(19) United States
(12) Patent Application Publication
(10) Pub. No.: US 2010/0110328 A1
(43) Pub. Date: May 6, 2010

(54) LIQUID CRYSTAL DISPLAY DEVICE

(75) Inventors: Yoshitaka TATEBAYASHI, Ooamishirasato (JP); Akira HOSAKA, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/608,267

(22) Filed: Oct. 29, 2009

(30) Foreign Application Priority Data
Oct. 31, 2008 (JP) 2008-281569

(51) Int. Cl. G02F 1/1333

(52) U.S. Cl. 349/58

(57) ABSTRACT

A small-sized liquid crystal display device which can enhance light utilization efficiency of light emitting diodes and also can reduce a thickness of the liquid crystal display device is provided. A flexible printed circuit board is connected to a terminal portion of a TFT substrate. In such a flexible printed circuit board, a light-emitting-diode-use flexible printed circuit board is folded and extends toward a back surface of a backlight. Light emitting diodes are arranged on the light-emitting-diode-use flexible printed circuit board in such a manner that the light emitting diodes are pressed against an edge portion of the light guide plate. Since the light emitting diodes and the edge portion of the light guide plate are brought into close contact with each other, the utilization efficiency of light from the light emitting diodes is enhanced. Further, since the light emitting diodes and the edge portion of the light guide plate which faces the light emitting diodes are provided outside the TFT substrate, a thickness of the whole liquid crystal display device can be reduced.

### CLAIM OF PRIORITY

The present application claims priority from Japanese application serial No. 2008-281569, filed on Oct. 31, 2008, the content of which is hereby incorporated by reference into this application.

### BACKGROUND OF THE INVENTION

1. Field of the Invention

The present invention relates to a display device, and more particularly to a liquid crystal display device which is small-sized and can reduce a thickness thereof.

2. Description of the Related Art

A liquid crystal display device includes a thin film transistors (TFT) substrate on which pixel electrodes, TFT and the like are formed in a matrix array, a color filter substrate which faces the TFT substrate in an opposed manner and forms color filters and the like thereon at positions corresponding to the pixel electrodes formed on the TFT substrate, and liquid crystal which is sandwiched between the TFT substrate and the color filter substrate. An image is formed by controlling optical transmissivity of liquid crystal molecules for every pixel.

The liquid crystal display device is flat and light-weighted and hence, the application fields of the liquid crystal display device have been spreading. A small-sized liquid crystal display device has been widely used in a mobile phone, a DSC (Digital Still Camera) and the like.

A liquid crystal display device has been requested to satisfy a demand for the increase of a size of a screen while maintaining a size of a profile thereof small.

JP-A-2008-145668 (patent document 1) discloses the following constitution which aims at the reduction of a size of a profile of a liquid crystal display device. The liquid crystal display device is configured such that a backlight is arranged on a back surface of a liquid crystal display panel constituted of a TFT substrate, a color filter substrate and the like, the liquid crystal display panel and the backlight are housed in the inside of a resin mold, and the resin mold is housed in the inside of a metal frame.

To reduce the size of the profile of the whole liquid crystal display device, an outer frame of the resin mold which surrounds the liquid crystal display panel is eliminated and, for compensating for the elimination of the outer frame, a portion of a diffusion sheet which constitutes a part of the backlight is arranged between the liquid crystal display panel and the metal frame so as to prevent the occurrence of cracks which may be caused when the liquid crystal display panel made of glass is brought into contact with metal.

### SUMMARY OF THE INVENTION

On the other hand, in applications such as a mobile phone and a DSC, there has been a strong demand for the reduction of thickness of a liquid crystal display device for reducing a thickness of the product per se. To satisfy such a demand, there has been proposed a technique which, after a TFT substrate and a color filter substrate are combined, makes these substrates thin by polishing outer surfaces of these substrates. There has been also proposed a technique which makes a thickness of a part which constitutes a backlight as small as possible. However, there exists a limit in efforts for reducing a thickness of the liquid crystal display device by merely reducing a thickness of a glass substrate of the liquid crystal display panel or by merely reducing a thickness of the part of the backlight such as a light guide plate, an optical sheet or the like.

Further, while a screen of a liquid crystal display device is requested to exhibit high brightness, the liquid crystal display device is also required to satisfy a demand for small power consumption since the liquid crystal display device is driven by a battery. An LED is used as a light source of a liquid crystal display device used in a mobile phone or a DSC. Accordingly, the increase of the LED light emitting efficiency satisfies the demand for low power consumption and the demand for high brightness. However, the enhancement of the light emitting efficiency of the LED cannot be achieved readily.

Accordingly, it is an object of the present invention to realize the enhancement of the brightness of a screen of a liquid crystal display device by enhancing the utilization efficiency of light emitted from an LED instead of solely relying on the light emitting efficiency of the LED. It is another object of the present invention to realize the reduction of thickness of a liquid crystal display device by changing the constitution of the liquid crystal display device instead of solely relying on the reduction of thicknesses of respective parts of the liquid crystal display device.

To explain means which are specifically provided for achieving the above-mentioned objects of the present invention, they are as follows.

(1) According to one aspect of the present invention, there is provided a liquid crystal display device comprising: a liquid crystal display panel including a TFT substrate on which pixels each of which includes a pixel electrode and a thin film transistor are formed in a matrix array, a color filter substrate on which color filters are formed, a lower polarizer which is adhered to the TFT substrate, and an upper polarizer which is adhered to the color filter substrate; and a backlight, wherein the backlight includes a light emitting diode and a light guide plate which has an edge portion thereof arranged to face the light emitting diode, a flexible printed circuit board is connected to a terminal portion of the liquid crystal display panel, the light emitting diode is mounted on the flexible printed circuit board, and the flexible printed circuit board is folded and extends over a back surface of the backlight, and the light emitting diode is mounted on the flexible printed circuit board at a surface thereof on a side opposite to a surface thereof which faces the edge portion of the light guide plate.

(2) In the liquid crystal display device having the constitution (1), the light emitting diode may have the surface thereof on a side opposite to the surface thereof which faces the edge portion of the light guide plate positioned outside the TFT substrate.

(3) According to another aspect of the present invention, there is provided a liquid crystal display device comprising: a liquid crystal display panel including a TFT substrate on which pixels each of which includes a pixel electrode and a thin film transistor are formed in a matrix array, a color filter substrate on which color filters are formed, a lower polarizer which is adhered to the TFT substrate, and an upper polarizer which is adhered to the color filter substrate; and a backlight, wherein the backlight includes a light emitting diode, a light guide plate which has an edge portion thereof arranged to face the light emitting diode, and an optical sheet which is arranged on the light guide plate, the light guide plate has a large plate thickness at a portion thereof which faces the light emitting diode and a small plate thickness at a position where the optical sheet is arranged, and the light emitting diode and the portion of the light guide plate which has the large plate thickness are positioned outside the TFT substrate.

(4) In the liquid crystal display device having the constitution (3), a flexible printed circuit board may be connected to a terminal portion of the liquid crystal display panel, the light emitting diode may be mounted on the flexible printed circuit board, and the flexible printed circuit board may be folded and may extend over a back surface of the backlight, and the light emitting diode may be mounted on the flexible printed circuit board at a surface thereof on a side opposite to a surface thereof which faces the edge portion of the light guide plate.

(5) According to still another aspect of the present invention, there is provided a liquid crystal display device comprising: a liquid crystal display panel including a TFT substrate on which pixels each of which includes a pixel electrode and a thin film transistor are formed in a matrix array, a color filter substrate on which color filters are formed, a lower polarizer which is adhered to the TFT substrate, and an upper polarizer which is adhered to the color filter substrate; and a backlight, wherein a portion of the TFT substrate corresponding to a terminal portion has a large plate thickness, and a portion of the TFT substrate to which the lower polarizer is adhered has a small plate thickness, the backlight includes a light emitting diode, a light guide plate which has an edge portion thereof arranged to face the light emitting diode, and an optical sheet which is arranged on the light guide plate, the light guide plate has a large plate thickness at a portion thereof which faces the light emitting diode and a small plate thickness at a position where the optical sheet is arranged, and the light emitting diode and the portion of the light guide plate which has the large plate thickness are positioned outside the TFT substrate.

(6) In the liquid crystal display device having the constitution (5), a flexible printed circuit board may be connected to a terminal portion of the liquid crystal display panel, the light emitting diode may be mounted on the flexible printed circuit board, and the flexible printed circuit board may be folded and extends over a back surface of the backlight, and the light emitting diode may be mounted on a surface of the flexible printed circuit board at a surface thereof on a side opposite to a surface thereof which faces the edge portion of the light guide plate.

According to the present invention, in the small-sized liquid crystal display device including the backlight in which the light emitting diode is arranged to face the edge portion of the light guide plate, it is possible to bring the light emitting diode and the edge portion of the light guide plate into close contact with each other. Due to such constitution, it is possible to increase the utilization efficiency of light emitted from the light emitting diode and hence, it is possible to reduce the power consumption of the light emitting diode.

According to another aspect of the present invention, the light emitting diode and the portion of the light guide plate which faces the light emitting diode can be positioned outside the TFT substrate and hence, it is possible to reduce a thickness of the whole liquid crystal display device.

### BRIEF DESCRIPTION OF THE DRAWINGS

FIG. 1 is a cross-sectional view showing a liquid crystal display device according to an embodiment 1 of the present invention;

FIG. 2 is a cross-sectional view showing a liquid crystal display device according to an embodiment 2 of the present invention;

FIG. 3 is a cross-sectional view showing a liquid crystal display device according to an embodiment 3 of the present invention;

FIG. 4 is a cross-sectional view showing a liquid crystal display device according to an embodiment 4 of the present invention;

FIG. 5 is a plan view of a liquid crystal display device;

FIG. 6 is a back view of the liquid crystal display device;

FIG. 7 is a back developed view of the liquid crystal display device;

FIG. 8 is a cross-sectional view of a conventional liquid crystal display device; and

FIG. 9 is an exploded perspective view of a group of optical sheets.

### DESCRIPTION OF THE PREFERRED EMBODIMENTS

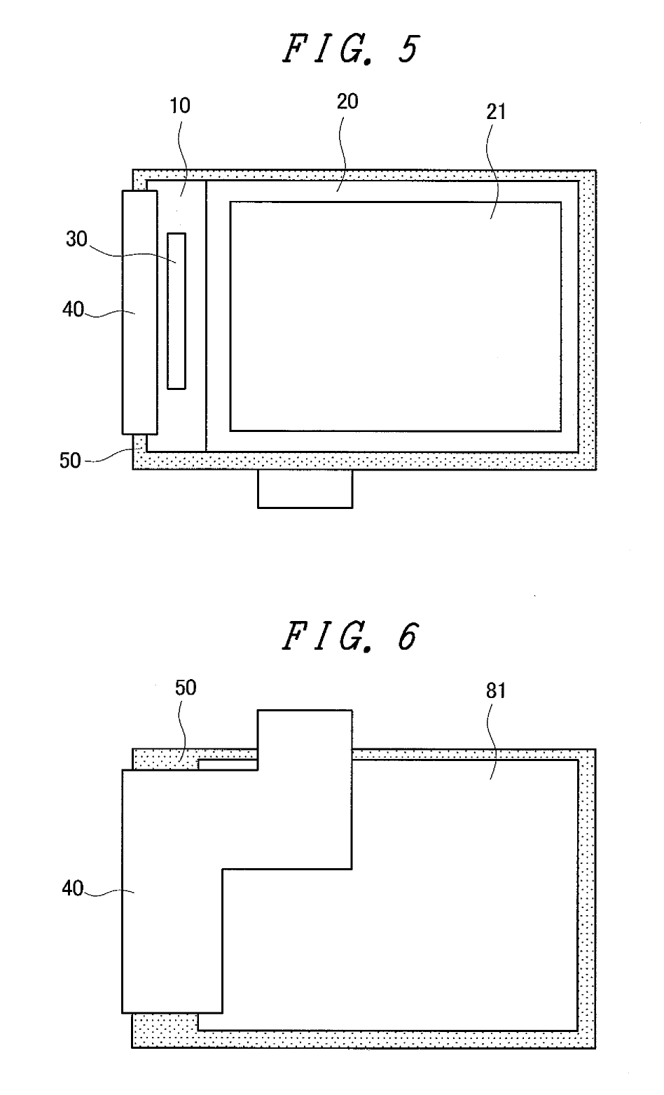

Prior to the explanation of the specific constitution of the present invention, the constitution of a liquid crystal display device of a related art which includes a backlight is explained. FIG. 5 is a plan view of a mobile-phone-use liquid crystal display device. Hereinafter, in this specification, the term “liquid crystal cell” implies the structure which is constituted of a TFT substrate 10, a color filter substrate 20 and liquid crystal sealed in a gap defined between the TFT substrate 10 and the color filter substrate 20. The term “liquid crystal display panel” implies the structure which is formed by adhering an upper polarizer 21 and a lower polarizer 11 to the liquid crystal cell. The term “liquid crystal display device” means the structure which is formed by combining a backlight with the liquid crystal display panel.

In FIG. 5, the liquid crystal display panel is placed in a resin mold. The liquid crystal display panel is fixed to a stepped portion (not shown in the drawing) of the resin mold 50 using a pressure-sensitive adhesive double coated tape or an adhesive light blocking film. The upper polarizer 21 is adhered to a portion of the liquid crystal display panel which corresponds to a display region.

The TFT substrate 10 is formed larger than the color filter substrate 20 in size, and a portion of the TFT substrate 10 projecting from the color filter substrate 20 constitutes a terminal portion 12. An IC driver 30 is formed on the terminal portion 12. A flexible printed circuit board 40 is connected to terminals formed on the terminal portion 12. The flexible printed circuit board 40 surrounds an edge portion of the resin mold 50 and, thereafter, extends toward a back side of the resin mold 50.

FIG. 6 is a back view of the liquid crystal display device shown in FIG. 5. In FIG. 6, the flexible printed circuit board 40 which starts from the terminal portion 12 of the TFT substrate 10 (not shown in the drawing) surrounds the edge portion of the mold and extends toward a back surface side of the resin mold 50. A reflection sheet 81 which constitutes a portion of the backlight is arranged on the back surface of the resin mold 50. As explained later, the reflection sheet 81 directs light radiated from the backlight toward a liquid crystal display panel side. The backlight not shown in the drawing is arranged in the inside of a frame of the resin mold 50.

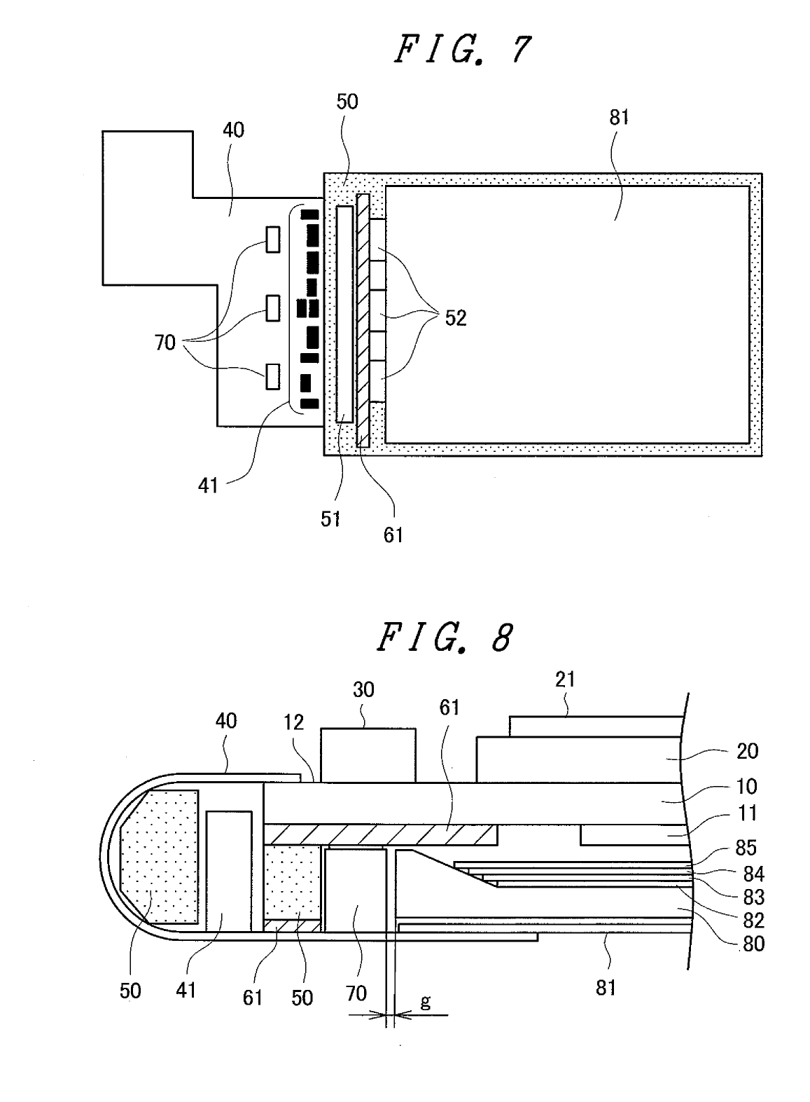

FIG. 7 is a view obtained by developing the flexible printed circuit board 40 from the liquid crystal display panel shown in FIG. 6 which is a back view for illustrating a surface of the flexible printed circuit board 40 and portions of the inside of the resin mold 50. In FIG. 7, light emitting diodes 70 and electronic parts 41 such as resistances and capacitors are arranged on the flexible printed circuit board 40. Three light emitting diodes 70 are mounted on the flexible printed circuit board 40.

In FIG. 7, an electronic part accommodating space 51 for accommodating the electronic parts 41 mounted on the flexible printed circuit board 40 is formed in the resin mold 50. Three light emitting diode accommodating spaces 52 for accommodating the light emitting diodes 70 are formed in the resin mold 50 corresponding to the number of the light emitting diodes 70. When the light emitting diodes 70 are arranged in the light emitting diode accommodating spaces 52, the light emitting diodes 70 are arranged to face an edge portion of a light guide plate 80 not shown in FIG. 7 in an opposed manner.

In FIG. 7, a pressure-sensitive adhesive double coated tape 61 is, for fixing the flexible printed circuit board 40 which is folded to the back surface of the resin mold 50, mounted on the resin mold 50 at a position between the electronic part accommodating space 51 and the light emitting diode accommodating spaces 52. In this manner, all of the electronic parts 41 mounted on the flexible printed circuit board 40 or the light emitting diodes 70 are accommodated in the electronic part accommodating space 51 or the light emitting diode accommodating spaces 52 formed on the resin mold 50. Accordingly, there is no possibility that a thickness of the liquid crystal display device is increased due to the electronic parts 41 and the light emitting diodes 70.

FIG. 8 is a cross-sectional view of a mobile-phone-use liquid crystal display device. In FIG. 8, a liquid crystal layer not shown in the drawing is sealed in a gap defined between a TFT substrate 10 on which pixel electrodes and TFTs are formed and a color filter substrate 20 on which color filters are formed. The TFT substrate 10 and the color filter substrate 20 are adhered to each other using a sealing material not shown in the drawing which is formed on a periphery of these substrates. Since liquid crystal can control only polarized light, a lower polarizer 11 is adhered to a TFT substrate 10 side on which light from a backlight is incident so as to polarize the light from the backlight to linear polarized light.

The linear polarized light is modulated by liquid crystal which is controlled by video signals for every pixel. On the color filter substrate 20, the color filter is formed for every pixel thus forming a color image. Light which passes through the color filter substrate 20 is polarized (analyzed) by the upper polarizer 21 and is viewed as an image with naked eyes.

There has been a demand for the reduction of the thickness of the whole liquid crystal display device. For this end, the reduction of thickness of the glass substrate such as the TFT substrate 10 or the color filter substrate 20 is effective. In an example shown in FIG. 7, both a thickness of the TFT substrate 10 and a thickness of the color filter substrate 20 are 0.18 mm respectively. The use of such a thin glass substrate, however, gives rise to drawbacks in manufacturing steps with respect to a mechanical strength, deflection and the like thus lowering a manufacturing yield. Further, a glass substrate which is available from markets is standardized in thickness such as 0.5 mm or 0.4 mm and hence, it is difficult to obtain a thin glass plate having a thickness of 0.18 mm from markets. Accordingly, after the liquid crystal cell is completed, the thicknesses of the TFT substrate 10 and the color filter substrate 20 are reduced by mechanical polishing or chemical polishing.

In FIG. 8, the TFT substrate 10 is formed larger than the color filter substrate 20 in size, and a portion of the TFT substrate 10 which projects from the color filter substrate 20 constitutes a terminal portion 12. An IC driver 30 is mounted on the terminal portion, and terminals which are connected to a flexible printed circuit board 40 are formed on the terminal portion 12. Since the terminal portion 12 is constituted of only the TFT substrate, a plate thickness of the terminal portion 12 is 0.18 mm. Accordingly, a mechanical strength of the terminal portion 12 is low compared to mechanical strengths of other portions. Although the liquid crystal display panel is placed on a resin mold 50, for preventing the liquid crystal display panel from being separated from the resin mold 50, the liquid crystal display panel is fixed to the resin mold 50 using an adhesive light blocking film. A light blocking tape 60 plays a role of preventing leaking of light emitted from light emitting diodes 70 toward a TFT substrate 10 side.

In FIG. 8, the liquid crystal display panel is placed on the resin mold 50 which accommodates a light source, optical parts and the like therein. The flexible printed circuit board 40 is connected to the terminal portion 12 of the TFT substrate 10. Electronic parts 41 such as resistances and capacitors are arranged on the flexible printed circuit board 40 and, further, light emitting diodes 70 which constitute the backlight are arranged on the flexible printed circuit board 40.

The flexible printed circuit board 40 is folded so as to surround an edge portion of the resin mold 50 and extends toward a back side of the resin mold 50. The flexible printed circuit board 40 is fixed to the resin mold 50 using a pressure-sensitive adhesive double coated tape 61 on a back surface of the resin mold 50. The electronic parts 41 arranged on the flexible printed circuit board 40 are accommodated in an electronic part accommodating space 51 which is formed in the resin mold 50. Further, the light emitting diodes 70 are accommodated in a light emitting diode accommodating space 52 which is formed in the resin mold 50. Accordingly, there exists no possibility that the liquid crystal display device has a large thickness as a whole due to the presence of the electronic parts 41 and the light emitting diodes 70.

The backlight is arranged on a back side of the liquid crystal display panel. The backlight is housed in the resin mold 50. In FIG. 8, a light guide plate 80 is arranged to face the light emitting diodes 70. A portion of the light guide plate 80 which faces the light emitting diodes 70 has a large thickness corresponding to a size of the light emitting diodes 70. However, other portions of the light guide plate 80, that is, portions on which optical sheets are placed have a small thickness for reducing the thickness of the whole liquid crystal display device. The light guide plate 80 has a function of directing light which is incident on the light guide plate 80 from the light emitting diodes 70 in the lateral direction toward the liquid crystal display panel side.

A reflection sheet 81 is arranged below the light guide plate 80. The reflection sheet 81 reflects light which extends downwardly from the light guide plate 80 and directs the light toward the liquid crystal display panel, and enhances the utilization efficiency of light emitted from the light emitting diodes. A group of optical sheets is arranged on the light guide plate 80. The group of optical sheets is sequentially arranged in order of a lower diffusion sheet 82, a lower prism sheet 83, an upper prism sheet 84, and an upper diffusion sheet 85 from a light guide plate 80 side.

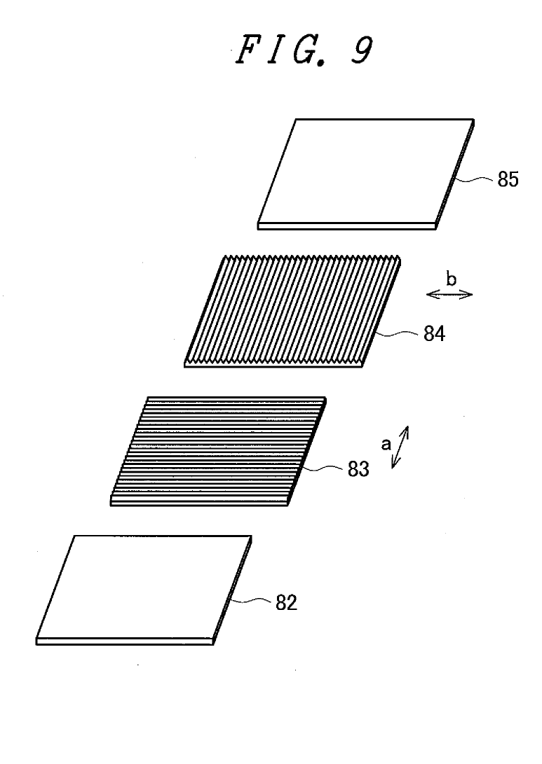

FIG. 9 is an exploded perspective view of the group of optical sheets. A lowermost sheet described in FIG. 9 is the lower diffusion sheet 82. A light which is radiated toward the liquid crystal display panel side from the light guide plate 80 has brightness irregularities such that the light radiated from a portion of the light guide plate 80 in the vicinity of the light emitting diodes 70 is relatively brighter than the light radiated from other portions of the light guide plate 80. The lower diffusion sheet 82 plays a role of making the brightness of light emitted from the backlight uniform by alleviating such brightness irregularities.

The lower prism sheet 83 is arranged on the lower diffusion sheet 82. As shown in FIG. 9, for example, prisms each of which has a triangular cross section are formed on the lower prism sheet 83 in such a manner that the prisms extend in the lateral direction and are arranged in the longitudinal direction. An arrangement pitch of the respective prisms is set to approximately 50 μm. In FIG. 9, the lower prism sheet 83 plays a role of enhancing the utilization efficiency of light by directing light which tends to spread in the direction “a” toward the direction perpendicular to the lower prism sheet 83.

The upper prism sheet 84 is arranged on the lower prism sheet 83. As shown in FIG. 9, for example, prisms each of which has a triangular cross section are formed on the upper prism sheet 84 in such a manner that the prisms extend in the longitudinal direction and are arranged in the lateral direction. An arrangement pitch of the respective prisms is set to approximately 50 μm. In FIG. 9, the upper prism sheet 84 plays a role of enhancing the utilization efficiency of light by directing light which tends to spread in the direction “b” toward the direction perpendicular to the upper prism sheet 84.

In FIG. 9, the upper diffusion sheet 85 is arranged on the upper prism sheet 84. The upper diffusion sheet 85 has a function of suppressing the generation of moiré on the display screen of the liquid crystal display device. That is, the brightness of a light emitted from the lower prism sheet 83 or the upper prism sheet 84 is microscopically changed periodically corresponding to the prism pitch.

On the other hand, on the TFT substrate 10 of the liquid crystal display panel, scanning lines which extend in the lateral direction and are arranged in the longitudinal direction are formed, for example. Accordingly, portions which allow the transmission of light and portions which block light are periodically formed in the longitudinal direction on the TFT substrate 10 due to the presence of the scanning lines. Further, on the TFT substrate 10 of the liquid crystal display panel, video signal lines which extend in the longitudinal direction and are arranged in the lateral direction are formed. Accordingly, portions which allow the transmission of light and portions which block light are periodically formed in the lateral direction on the TFT substrate 10 due to the presence of the video signal lines.

Due to such a constitution, the interference of light is generated between light which passes through the lower prism sheet 83 and the upper prism sheet 84 and the TFT substrate 10 of the liquid crystal display panel, and this interference of light generates moiré. The upper diffusion sheet 85 plays a role of suppressing the generation of moiré by alleviating the interference between light and the scanning lines or the video signal lines formed on the TFT substrate 10 due to alleviation of the difference in intensity of light which passes through the prism sheets.

As described above, the explanation of the group of optical sheets is made by taking a case where the group of optical sheets includes four sheets, that is, the lower diffusion sheet 82, the lower prism sheet 83, the upper prism sheet 84, and the upper diffusion sheet 85 as an example. However, in the liquid crystal display device to which the present invention is applied, four sheets are not always necessary. For example, the upper diffusion sheet 85 may be omitted or one of the prism sheets may be omitted.

Returning to the constitution shown in FIG. 8, the group of optical sheets overlaps with the light guide plate 80. A gap is formed between the upper diffusion sheet 85 which constitutes an uppermost optical sheet out of the group of optical sheets and the lower polarizer 11 of the liquid crystal display panel. This gap is formed for preventing the generation of flaws on the lower polarizer 11 or the upper diffusion sheet 85 due to rubbing between the lower polarizer 11 and the upper diffusion sheet 85.

As shown in FIG. 8, the light emitting diodes 70 are mounted on the flexible printed circuit board 40 and are accommodated in the light emitting diode accommodating space 52. It is ideal that the light emitting diodes 70 and the edge portion of the light guide plate 80 are brought into close contact with each other. However, in an actual liquid crystal display device, a gap “g” is formed between the light guide plate 80 and the light emitting diodes 70 due to the deflection, the spring-back or the like of the flexible printed circuit board 40.

When the gap “g” is formed, the utilization efficiency of light emitted from the light emitting diodes 70 is extremely lowered. For example, when a gap “g” of approximately 0.1 mm exists between the light guide plate 80 and the light emitting diodes 70 in FIG. 8, the utilization efficiency of light emitted from the light emitting diodes 70 is lowered by approximately 10%. The present invention aims at, as explained in the following embodiments, the enhancement of the utilization efficiency of light emitted from the light emitting diodes 70 by making the gap “g” between the edge portion of the light guide plate 80 and the light emitting diodes 70 as small as possible.

Further, the light emitting diode is requested to have a size or a height to some extent. As shown in FIG. 8, conventionally, the light emitting diodes 70 are arranged below the TFT substrate 10 and the light blocking tape 60. Accordingly, a thickness of the liquid crystal display device is determined by taking all of a height of the light emitting diodes 70, a thickness of the light blocking tape 60, and a thickness of the TFT substrate 10 into consideration. Here, the edge portion of the light guide plate 80 is aligned with the height of the light emitting diodes 70 and hence, the thickness of the edge portion of the light guide plate 80 also influences the thickness of the liquid crystal display device in the same manner.

The present invention aims at, as explained in the following embodiments, the reduction of a thickness of the liquid crystal display device by arranging the TFT substrate 10, the light emitting diodes 70 and the light guide plate 80 such that the TFT substrate 10 does not overlap with the light emitting diodes 70 or the edge portion of the light guide plate 80. Hereinafter, specific embodiments of the present invention are explained.

### Embodiment 1

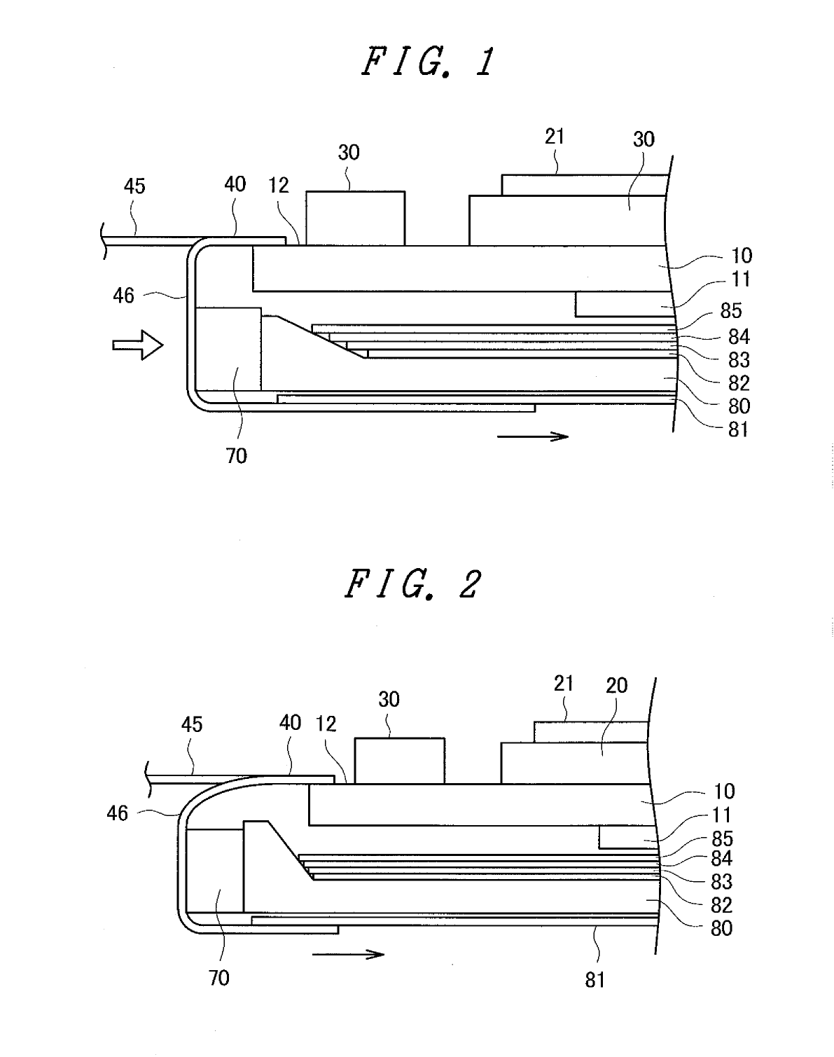

The embodiment 1 is directed to an example which enhances the utilization efficiency of light emitted from light emitting diodes 70 by improving the close contact between the light emitting diodes 70 and an edge portion of a light guide plate 80. FIG. 1 is a cross-sectional view of a liquid crystal display device showing the embodiment 1 of the present invention. In FIG. 1, the edge portion of the light guide plate 80 is present in the vicinity of an edge portion of a TFT substrate 10.

In FIG. 1, a flexible printed circuit board 40 is connected to a terminal portion 12 of the TFT substrate 10. With respect to this flexible printed circuit board 40, a light-emitting-diode-use flexible printed circuit board 46 which supplies electricity and the like to the light emitting diodes 70 is folded and extends to and along a back surface of a liquid crystal display panel and a back surface of a backlight. In FIG. 1, a main flexible printed circuit board 45 on which electronic parts 41 and the like are mounted is not bent or folded and extends frontwardly. The main flexible printed circuit board 45 is bent or the like at the time of assembling the liquid crystal display device into an apparatus and is connected to a power source or a signal source of the apparatus.

This embodiment is characterized in that a connection point where the light emitting diodes 70 and the light-emitting-diode-use flexible printed circuit board 46 are connected with each other is arranged at a surface of the light emitting diodes 70 on a side opposite to a surface of the light emitting diodes 70 which faces the light guide plate 80. Due to such an arrangement, when the light-emitting-diode-use flexible printed circuit board 46 is pulled in the direction indicated by an arrow shown in FIG. 1, the light emitting diodes 70 are brought into close contact with the edge portion of the light guide plate 80.

That is, the technical feature of this embodiment lies in that when the light-emitting-diode-use flexible printed circuit board 46 is pulled in the direction indicated by the arrow, the light emitting diodes 70 are pressed against the light guide plate 80 in the direction perpendicular to the light guide plate 80 as indicated by a white arrow. Due to such a constitution, the light emitting diodes 70 are pressed against the edge portion of the light guide plate 80 uniformly without inclination with respect to the edge portion of the light guide plate 80.

In FIG. 1, after pulling the light-emitting-diode-use flexible printed circuit board 46 in the direction indicated by the arrow, a stopper may be provided to a distal end of the light-emitting-diode-use flexible printed circuit board 46 so as to maintain the close contact between the light emitting diodes 70 and the light guide plate 80.

The liquid crystal display device shown in FIG. 1 is housed in a resin mold 50 or a frame. In housing the liquid crystal display device, there may be a case where the light emitting diodes 70 are pressed by the resin mold 50 or a wall of the frame. Also in this case, the light emitting diodes 70 receive a pressing force as indicated by the white arrow in FIG. 1 and hence, it is possible to enhance the close contact between the edge portion of the light guide plate 80 and the light emitting diodes 70.

Even when the light guide plate 80 and the light emitting diodes 70 are spaced-apart from each other by a distance of mere approximately 0.1 mm, the utilization efficiency of light emitted from the light emitting diodes 70 is lowered by approximately 10%. Further, when the inclination is present between the light emitting diodes 70 and the edge portion of the light guide plate 80, the utilization efficiency of light emitted from the light emitting diodes 70 is further lowered. According to this embodiment, the close contact between the light emitting diodes and the edge portion of the light guide plate is increased and, at the same time, the inclination of the light emitting diodes is eliminated. Accordingly, it is possible to enhance the utilization efficiency of light emitted from the light emitting diodes 70 in the liquid crystal display device by 10% or more thus enhancing the brightness of a display screen. When it is sufficient for a display screen to maintain the same brightness, electricity supplied to the light emitting diodes 70 can be reduced by 10% or more thus prolonging a time until a battery is recharged.

### Embodiment 2

This embodiment provides the constitution which can reduce a thickness of the liquid crystal display device. FIG. 2 is a cross-sectional view showing the constitution of this embodiment. In FIG. 2, a portion of a light guide plate 80 in the vicinity of an edge portion of the light guide plate 80 which faces light emitting diodes 70 has a large plate thickness. Further, the portion is positioned outside an edge portion of a TFT substrate 10. The light emitting diodes 70 are arranged to be in close contact with the edge portion of the light guide plate 80.

The light emitting diodes 70 require a predetermined height. The edge portion of the light guide plate 80 which faces the light emitting diodes 70 also requires a height substantially equal to the height of the light emitting diodes 70. As shown in FIG. 7, when the light emitting diodes 70 or the edge portion of the light guide plate 80 which faces the light emitting diodes 70 are arranged below the TFT substrate 10, a thickness of the liquid crystal display device inevitably includes a sum of a thickness of the TFT substrate 10 and a thickness of the light emitting diode 70 and hence, the reduction of the thickness of the liquid crystal display device is limited.

According to the present invention, by arranging the light emitting diodes 70 and the edge portion of the light guide plate 80 which faces the light emitting diodes 70, that is, a portion of the light guide plate 80 having a large thickness outside the TFT substrate 10, the above-mentioned limit can be eliminated thus realizing the large reduction of the thickness of the liquid crystal display device.

As shown in FIG. 2, in the same manner as the embodiment 1, a connection point where the light emitting diodes 70 and the light-emitting-diode-use flexible printed circuit board 46 are connected with each other is arranged at a surface of the light emitting diodes 70 on a side opposite to a surface of the light emitting diodes 70 which faces the light guide plate 80. Due to such an arrangement, when the light-emitting-diode-use flexible printed circuit board 46 is pulled in the direction indicated by an arrow, the light emitting diodes 70 are brought into close contact with the edge portion of the light guide plate 80. Accordingly, also in this embodiment, in the same manner as the embodiment 1, it is possible to enhance the utilization efficiency of light emitted from the light emitting diodes 70 thus reducing the power consumption of the light emitting diodes 70.

### Embodiment 3

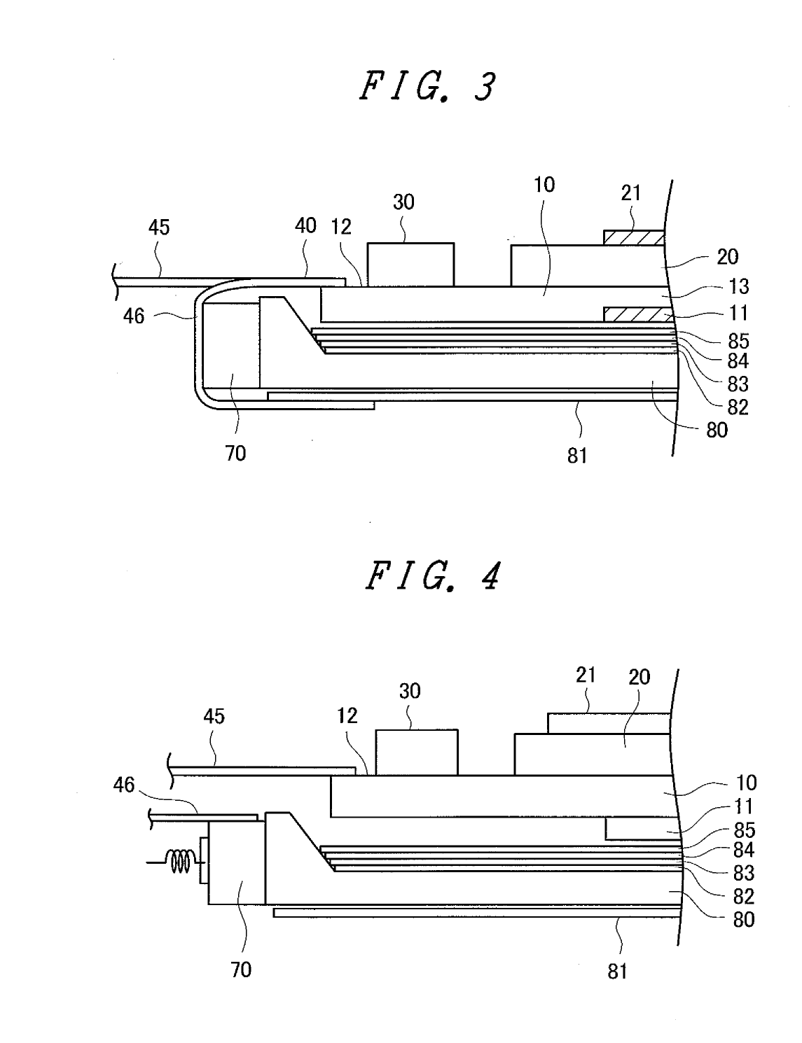

FIG. 3 is a cross-sectional view of a liquid crystal display device showing an embodiment 3 of the present invention. In the embodiment 2, as shown in FIG. 2, the thickness of the whole liquid crystal display device is reduced by arranging the light emitting diodes 70 and the edge portion of the light guide plate 80 outside the TFT substrate 10. In the constitution of the embodiment 2, as shown in FIG. 2, parts of the liquid crystal display device which define the thickness of the whole liquid crystal display device are the light guide plate 80, the group of optical sheets which is placed on the light guide plate 80, the lower polarizer 11, the TFT substrate 10, the color filter substrate 20, and the upper polarizer 21.

According to the embodiment 3 shown in FIG. 3, a stepped portion is formed on the TFT substrate 10. That is, while a plate thickness of a portion of the TFT substrate 10 corresponding to the terminal portion 12 is maintained as it is, a plate thickness of a portion of the TFT substrate 10 to which the lower polarizer 11 is adhered is reduced by chemical polishing. Then, the lower polarizer 11 is adhered to a small plate-thickness portion 13 of the TFT substrate 10 whose thickness is reduced.

Due to such a constitution, it is no more necessary to take a thickness of the lower polarizer 11 into consideration in determining the thickness of the whole liquid crystal display device. Accordingly, it is possible to realize the further reduction of the thickness of the whole liquid crystal display device. In this embodiment, as shown in FIG. 3, a lower surface of the lower polarizer 11 is made coplanar with a lower surface of the TFT substrate 10. It is needless to say, however, that even when the thickness of the small plate-thickness portion 13 of the TFT substrate 10 is not reduced to such an extent, the above-mentioned advantageous effects can be acquired by reducing the thickness of the small plate-thickness portion 13 to an extent that the lower surface of the lower polarizer 11 is positioned closer to a backlight side than the lower surface of the TFT substrate 10.

Although the thickness of the portion of the TFT substrate 10 to which the lower polarizer 11 is adhered is reduced, a mechanical strength of the liquid crystal display panel is not lowered as a whole. That is, a portion of the liquid crystal display panel having a weakest mechanical strength is the terminal portion 12 of the TFT substrate 10, which is constituted of only one sheet of TFT substrate 10. In this embodiment, a plate thickness of the terminal portion 12 is not reduced. Further, the color filter substrate 20 is adhered to the portion of the TFT substrate 10 whose plate thickness is reduced and hence, such a portion exhibits a larger mechanical strength than the terminal portion 12 in a liquid crystal display panel state. Due to such a constitution, this embodiment can reduce the thickness of the whole liquid crystal display device without substantially decreasing the mechanical strength of the liquid crystal display panel.

### Embodiment 4

FIG. 4 shows the constitution according to an embodiment 4 of the present invention. As shown in FIG. 4, in the same manner as the embodiment 2, light emitting diodes 70 and an edge portion of a light guide plate 80 which faces the light emitting diodes 70 are arranged outside a TFT substrate 10. In FIG. 4, both a main flexible printed circuit board 45 which is connected to the TFT substrate 10 and a light-emitting-diode-use flexible printed circuit board 46 which is connected to the light emitting diodes 70 extend outward from a liquid crystal display device without being folded toward a back surface side of a backlight. These flexible printed circuit boards 45, 46 are connected to an external power source or an external signal source respectively when the liquid crystal display device is assembled into a set in such a manner that the respective flexible printed circuit boards 45, 46 are folded so as to prevent the increase of the thickness of the whole liquid crystal display device.

In FIG. 4, the liquid crystal display panel and the backlight are housed in a resin mold 50 or a frame. Here, the light emitting diodes 70 are pressed by the resin mold 50 or a wall of the frame so that these parts are brought into close contact with the edge portion of the light guide plate 80. FIG. 4 schematically shows such a state using a spring. A coil spring is schematically shown in FIG. 4, and the spring may be made of any material provided that the material exhibits spring property.

As described above, also in this embodiment, the light emitting diodes 70 are brought into close contact with the edge portion of the light guide plate 80 and hence, it is possible to enhance the utilization efficiency of light emitted from the light emitting diodes 70 thus suppressing the power consumption of the light emitting diodes 70. Further, the light emitting diodes 70 and the edge portion of the light guide plate 80 which faces the light emitting diodes 70 are arranged outside the TFT substrate 10 and hence, it is possible to reduce the thickness of the liquid crystal display device as a whole.

Here, also in the constitution shown in FIG. 4, by setting the thickness of the TFT substrate 10 in two stages such that a plate thickness of a portion of the TFT substrate 10 to which the lower polarizer 11 is adhered is reduced, it is possible to decrease the thickness of the whole liquid crystal display device.

What is claimed is:

1. A liquid crystal display device comprising:
a liquid crystal display panel including
a TFT substrate on which pixels each of which includes a pixel electrode and a thin film transistor are formed in a matrix array,
a color filter substrate on which color filters are formed,
a lower polarizer which is adhered to the TFT substrate, and
an upper polarizer which is adhered to the color filter substrate; and
a backlight, wherein
the backlight includes a light emitting diode and a light guide plate which has an edge portion thereof arranged to face the light emitting diode,
a flexible printed circuit board is connected to a terminal portion of the liquid crystal display panel, the light emitting diode is mounted on the flexible printed circuit board, and the flexible printed circuit board is folded and extends over a back surface of the backlight, and
the light emitting diode is mounted on the flexible printed circuit board at a surface thereof on a side opposite to a surface thereof which faces the edge portion of the light guide plate.

2. A liquid crystal display device according to claim 1, wherein the light emitting diode has the surface thereof on a side opposite to the surface thereof which faces the edge portion of the light guide plate positioned outside the TFT substrate.

3. A liquid crystal display device comprising:
a liquid crystal display panel including
a TFT substrate on which pixels each of which includes a pixel electrode and a thin film transistor are formed in a matrix array,
a color filter substrate on which color filters are formed,
a lower polarizer which is adhered to the TFT substrate, and an upper polarizer which is adhered to the color filter substrate; and
a backlight, wherein
the backlight includes a light emitting diode, a light guide plate which has an edge portion thereof arranged to face the light emitting diode, and an optical sheet which is arranged on the light guide plate,
the light guide plate has a large plate thickness at a portion thereof which faces the light emitting diode and a small plate thickness at a position where the optical sheet is arranged, and
the light emitting diode and the portion of the light guide plate which has the large plate thickness are positioned outside the TFT substrate.

4. A liquid crystal display device according to claim 3, wherein a flexible printed circuit board is connected to a terminal portion of the liquid crystal display panel, the light emitting diode is mounted on the flexible printed circuit board, and the flexible printed circuit board is folded and extends over a back surface of the backlight, and
the light emitting diode is mounted on the flexible printed circuit board at a surface thereof on a side opposite to a surface thereof which faces the edge portion of the light guide plate.

5. A liquid crystal display device comprising:
a liquid crystal display panel including
a TFT substrate on which pixels each of which includes a pixel electrode and a thin film transistor are formed in a matrix array,
a color filter substrate on which color filters are formed,
a lower polarizer which is adhered to the TFT substrate, and
an upper polarizer which is adhered to the color filter substrate; and
a backlight, wherein
a portion of the TFT substrate corresponding to a terminal portion has a large plate thickness, and a portion of the TFT substrate to which the lower polarizer is adhered has a small plate thickness,
the backlight includes a light emitting diode, a light guide plate which has an edge portion thereof arranged to face the light emitting diode, and an optical sheet which is arranged on the light guide plate,
the light guide plate has a large plate thickness at a portion thereof which faces the light emitting diode and a small plate thickness at a position where the optical sheet is arranged, and
the light emitting diode and the portion of the light guide plate which has the large plate thickness are positioned outside the TFT substrate.

6. A liquid crystal display device according to claim 5, wherein a flexible printed circuit board is connected to a terminal portion of the liquid crystal display panel, the light emitting diode is mounted on the flexible printed circuit board, and the flexible printed circuit board is folded and extends over a back surface of the backlight, and
the light emitting diode is mounted on the flexible printed circuit board at a surface thereof on a side opposite to a surface thereof which faces the edge portion of the light guide plate.
